(19) United States
(12) Patent Application Publication
(10) Pub. No.: US 2017/0154452 A1
(43) Pub. Date: Jun. 1, 2017

(54) DISPLAY APPARATUS, DISPLAY CONTROL METHOD, AND RECORDING MEDIUM

(71) Applicants: Taeko ISHIZU, Kanagawa (JP); Kazuaki NAKAMURA, Kanagawa (JP)

(72) Inventors: Taeko ISHIZU, Kanagawa (JP); Kazuaki NAKAMURA, Kanagawa (JP)

(21) Appl. No.: 15/358,356

(22) Filed: Nov. 22, 2016

(30) Foreign Application Priority Data
Nov. 30, 2015 (JP) 2015-233723
Oct. 13, 2016 (JP) 2016-201438

(51) Int. Cl. G06T 11/60; G06T 1/00

(52) U.S. Cl. CPC G06T 11/60; G06T 1/00; H04N 9/3179

(57) ABSTRACT

A display apparatus displays a composite image on a display screen in a split screen display mode, the composite image including a plurality of images generated from a plurality of items of image data, which are respectively displayed on a plurality of split screens of the display screen. In response to receiving a switching request to switch the display screen from the split screen display mode to a full screen display mode to request to display one image on the display screen, the display apparatus performs operation of ending display of the respective images displayed on the split screens, while keeping display of the composite image that is displayed in the split screen display mode.

### CROSS-REFERENCE TO RELATED APPLICATIONS

This patent application is based on and claims priority pursuant to 35 U.S.C. §119(a) to Japanese Patent Application Nos. 2015-233723, filed on Nov. 30, 2015, and 2016-201438, filed on Oct. 13, 2016, in the Japan Patent Office, the entire disclosure of which is hereby incorporated by reference herein.

### BACKGROUND

Technical Field

The present invention relates to a display apparatus, a display control method, and a non-transitory recording medium.

Description of the Related Art

Projectors are provided with a well-known function of projecting a screen of a terminal such as a personal computer (hereinafter may be written as a “PC”) through a network. So far, technologies for projecting a screen input from one terminal onto the entire display screen (full screen) of a projector have been generally used. In contrast, there has been devised a projector provided with the function of displaying a plurality of screens input from a plurality of terminals on respective screens (split screens) obtained by splitting a display screen of the projector. The display screen of the projector can be switched between split screen and full screen modes.

### SUMMARY

Example embodiments of the present invention include a display apparatus, which displays a composite image on a display screen in a split screen display mode, the composite image including a plurality of images generated from a plurality of items of image data, which are respectively displayed on a plurality of split screens of the display screen. In response to receiving a switching request to switch the display screen from the split screen display mode to a full screen display mode to request to display one image on the display screen, the display apparatus performs operation of ending display of the respective images displayed on the split screens, while keeping display of the composite image that is displayed in the split screen display mode.

Example embodiments of the present invention include a display control method, and a non-transitory recording medium storing a display control program.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an exemplary network configuration of a display system according to an embodiment of the present invention;

FIG. 2 is a diagram illustrating the hardware configuration of a display apparatus according to the embodiment;

FIG. 3 is a block diagram illustrating the functional configuration of the display apparatus according to the embodiment;

FIG. 4 is a flowchart illustrating a process executed by a projection job manager illustrated in FIG. 3;

FIG. 5 illustrates an exemplary projection screen in a full screen projection mode in the embodiment;

FIG. 6 illustrates an exemplary projection screen and the manner of using a projection buffer in a split screen projection mode in the embodiment;

FIG. 7 is an illustration for describing problems in the case of switching the screen;

FIG. 8 is an illustration for describing problems in the case of switching the screen;

FIG. 9 is a flowchart illustrating a display switching process in the embodiment;

FIG. 10 illustrates a projection surface in the display switching process;

FIG. 11 illustrates the case where the display switching process is performed and the case where the display switching process is not performed in the embodiment;

FIG. 12 is an illustration for describing a display appearance in a full screen display mode in the embodiment; and

FIG. 13 is an illustration for describing a display appearance in another embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

An embodiment of the present invention disclosed hereinafter relates to a process of switching from split screen projection to full screen projection of a projector serving as an example of a display apparatus.

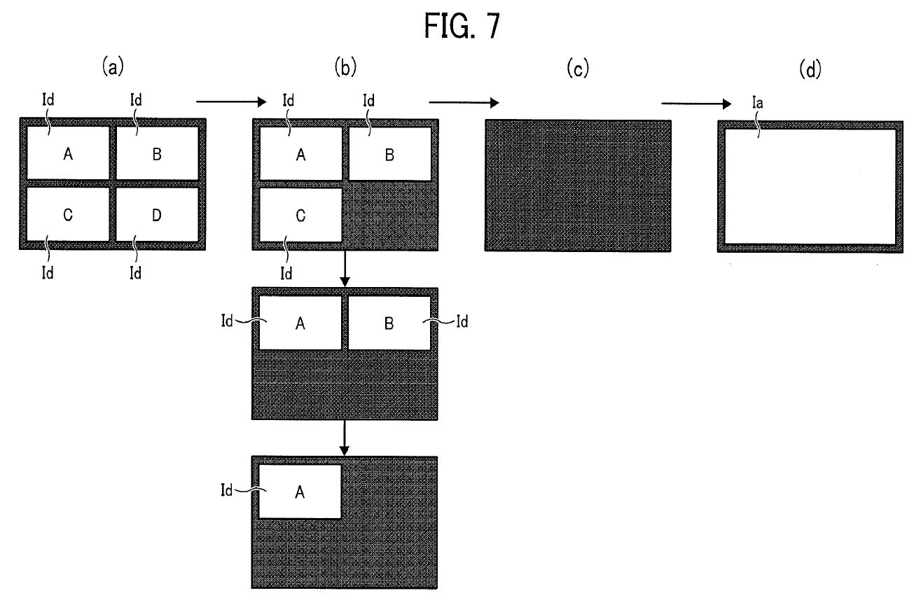

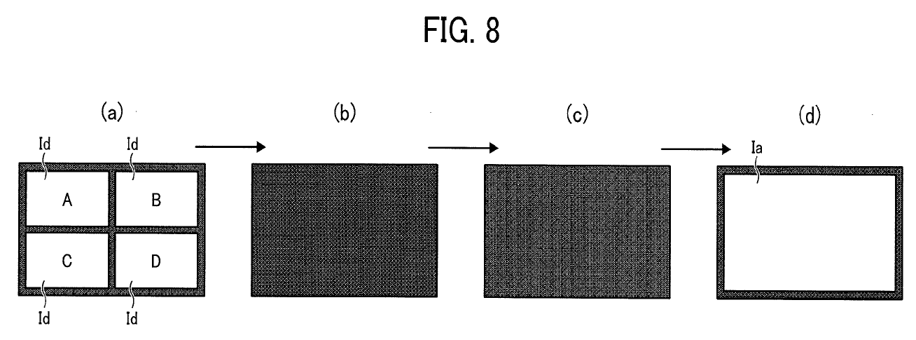

Now, a process of the related art will be described using FIGS. 7 and 8. To display split screens, generally, in response to reception of a projection request from a terminal, a projector generates jobs for the individual split screens, and the projector starts and ends the respective jobs. In this case, four jobs are generated in a four-split screen mode. To switch the screen from the split screen mode to the full screen mode, the projector completes all the jobs for the split screens, and then executes a job for a full screen in order to save computation resources.

However, such control involves one-by-one disappearance of the split screens at the time of switching the screen. When there are no more split screens, a full screen is displayed. The screen displayed in this transition looks poor to the user (FIG. 7).

Alternatively, another processing method as follows is conceivable. At the time of ending the split screen display mode, the method first resets the screen, ends jobs for the split screens, and then starts displaying a full screen. However, since a black screen is displayed at the time of resetting the screen, this black screen is projected for a long time, which also looks poor to the user (FIG. 8). Thus, it is preferable to avoid or minimize the above-mentioned inconveniences accompanying the switching of the display screen from the split screen mode to the full screen mode.

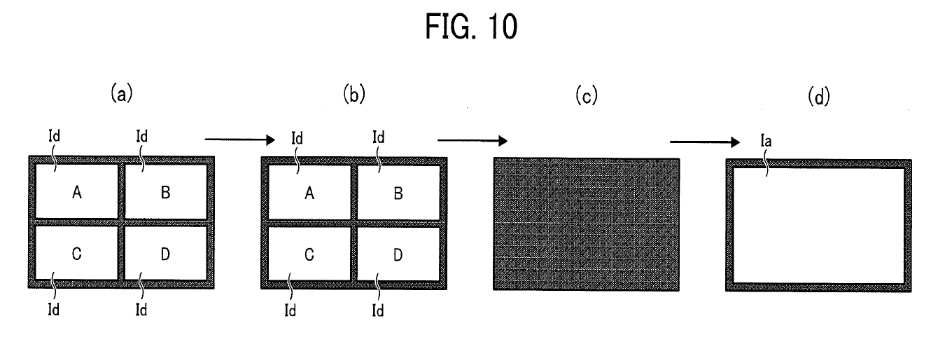

As will be described later, the display apparatus is controlled to leave the last screen of each terminal when ending the split screen mode in the embodiment (FIG. 10). Thus, it seems for the user as if the split screens disappear simultaneously and then the full screen projection starts. Hereinafter, this will be described in detail using the drawings.

### Exemplary Hardware Configuration

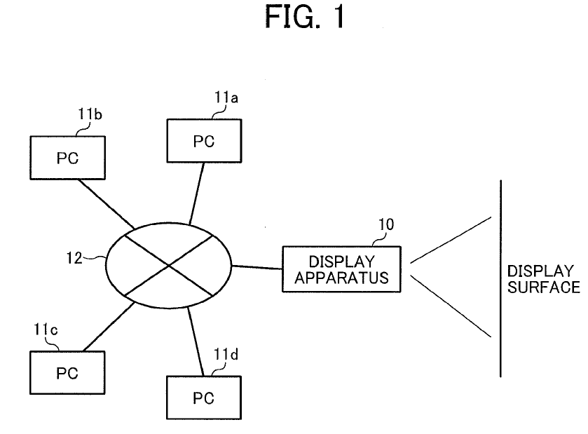

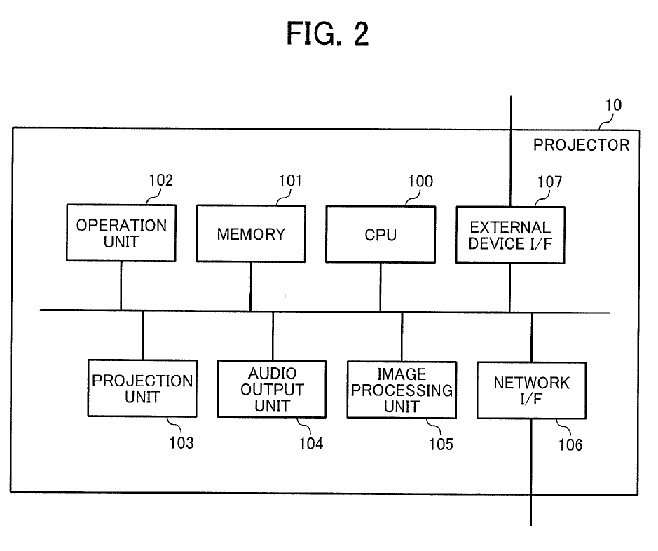

FIG. 1 is a diagram illustrating an exemplary network configuration of a display system according to the embodiment. FIG. 2 illustrates an exemplary hardware configuration of a display apparatus 10 included in the display system illustrated in FIG. 1.

As illustrated in FIG. 1, a plurality of personal computers (PCs) 11a to 11d (hereinafter collectively referred to a “PC 11”) and the display apparatus 10 are connected to be able to communicate with each other using a certain protocol via a network 12 such as a wireless local area network (LAN) in the embodiment. The display apparatus 10 receives a display request from the PC 11, and displays (projects in this case) an image input from the PC 11 (or an image designated to be displayed) on a display surface (projection surface in this case). In the embodiment, a projector is used as an example of the display apparatus 10.

As illustrated in FIG. 2, the display apparatus 10 includes a central processing unit (CPU) 100, a memory 101, an operation unit 102, a projection unit 103, an audio output unit 104, an image processing unit 105, a network interface (I/F) 106, and an external device I/F 107.

The image processing unit 105 is a circuit dedicated for image processing, which processes video data or still image data (hereinafter may be simply referred to as “input image data”) input to the image processing unit 105 on the basis of a certain format, and performs processing such as size-reduction or magnification and/or rotation in accordance with projection conditions. The processed image data is output to the projection unit 103.

The projection unit 103 outputs a red-green-blue (RGB) video signal on the basis of the processed image data output from the image processing unit 105. The projection unit 103 includes a projection optical system and the like.

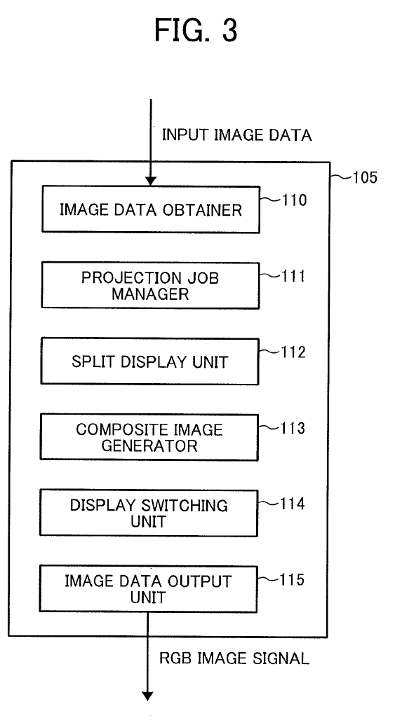

The memory 101 is a non-volatile memory and stores control programs and firmware of the display apparatus 10. The firmware provides the display apparatus 10 with certain functions using the hardware resources illustrated in FIG. 2. In other words, the control programs and the like stored in the memory 101 are called and executed by the CPU 100, thereby providing a functional configuration illustrated in FIG. 3. Under control of the CPU 100, the control programs and the like execute a certain process using the hardware resources such as the image processing unit 105. The operation unit 102 receives an operation signal generated by selecting a button or the like provided on the display apparatus 10, or an operation signal from a remote controller that communicates with the display apparatus 10, to receive an instruction from the user. The audio output unit 104 is realized by a loudspeaker, an audio processing circuit, and the like. When the input image data is a moving image, audio data is extracted from the input image data, the extracted audio data is subjected to decoding and sampling conversion, and an audio signal is output in accordance with audio output conditions. The external device I/F 107 obtains input image data from an external storage such as a Universal Serial Bus (USB) memory or a Secure Digital (SD) card. The network I/F 106 obtains input image data from an external device via a wired network or a wireless network. When data input from the network I/F 106 or the external device I/F 107 to the display apparatus 10 is a moving image or the like, the display apparatus 10 may further include a separator that separates the data into video data and audio data.

### Functional Configuration

FIG. 3 is a functional block diagram of the display apparatus 10. The elements illustrated in FIG. 3 are functions that are provided by causing, by the CPU 100, the hardware resources illustrated in FIG. 2 to operate on the basis of the control programs. Hereinafter, the individual functions will be described.

An image data obtainer 110 obtains content data accumulated in an external storage such as a USB memory or an SD card through the external device I/F 107. Alternatively, the image data obtainer 110 obtains, through the network I/F 106, content data from the PC 11, a tablet terminal, a smartphone terminal, or the like connected via the network 12.

A projection job manager 111 manages jobs regarding projection. In response to a user request received by the operation unit 102 to play or stop content, the projection job manager 111 manages generation or deletion of one or more jobs, and determines a projection method in accordance with the job(s).

A split display unit 112 splits the display screen into a plurality of split screens and simultaneously displays a plurality of images on the respective split screens. A composite image generator 113 combines the plurality of images displayed by the split display unit 112 to generate a composite image. Display switching unit 114 controls display switching between the split screen display mode and the full screen display mode. Although an example of displaying a plurality of images in the split screen display mode is described here, one and the same image may be displayed on the split screens.

An image data output unit 115 converts image data input from the display switching unit 114 or the like to an RGB image signal, and outputs the RGB image signal to the projection unit 103 (FIG. 2).

### Split Screen Display

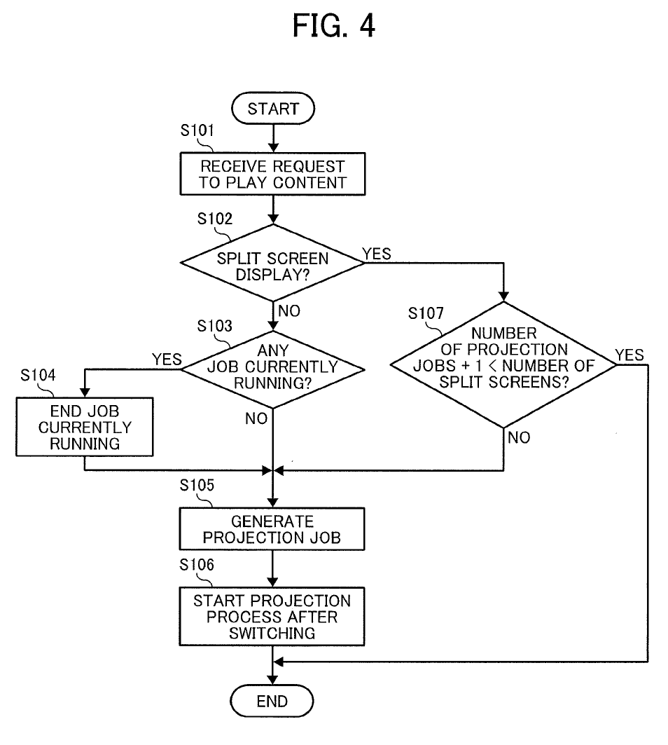

Next, a process of displaying split screens will be described in detail. Referring to FIG. 4, job generation will be described. FIG. 4 is a flowchart illustrating a process executed by the projection job manager 111 to which a request to play content is input.

Displaying content to be projected onto a full screen can be realized by one job; however, displaying different items of content on split screens requires generation and execution of a plurality of jobs since the image data obtainer 110 requires the following functions for the individual items of content.

As illustrated in FIG. 4, the projection job manager 111 receives a request from the user to play content (S101), and generates one or more jobs. In job generation, the projection job manager 111 first determines whether the display apparatus 10 is currently in the split screen mode (S102). When the current mode is the split screen mode, the projection job manager 111 generates projection jobs as long as the number of projection jobs does not exceed the number of split screens (S107 to S105). For example, when the number of split screens is four, the projection job manager 111 generates up to four projection jobs.

For the number of jobs, since the projection job manager 111 holds the managed jobs, the projection job manager 111 can obtain the number of jobs by counting the number of the managed jobs. For the number of split screens, a preset value held by the projection job manager 111 of the display apparatus 10 is used. The preset value may be held in advance by the display apparatus 10, or the user may set the preset value on the display apparatus 10. Alternatively, the preset value may be set from a terminal.

When the display apparatus 10 is currently not in the split screen mode (NO in S102), the projection job manager 111 checks whether there is another job currently running (S103). When there is no other job currently running (NO in S103), the projection job manager 111 generates a projection job (S105). When there is another job currently running (YES in S103), the projection job manager 111 forcedly ends this job (S104), and generates a projection job (S105). In the case of the full screen mode, the projection job manager 111 generates one projection job.

Whether there is another job currently running is determined by determining whether there is a job held by the projection job manager 111.

When a projection job is generated by the projection job manager 111 (S105), the display switching unit 114 switches the display screen, and then controls the image data output unit 115 and the like to execute a projection process (S106).

### Projection Output

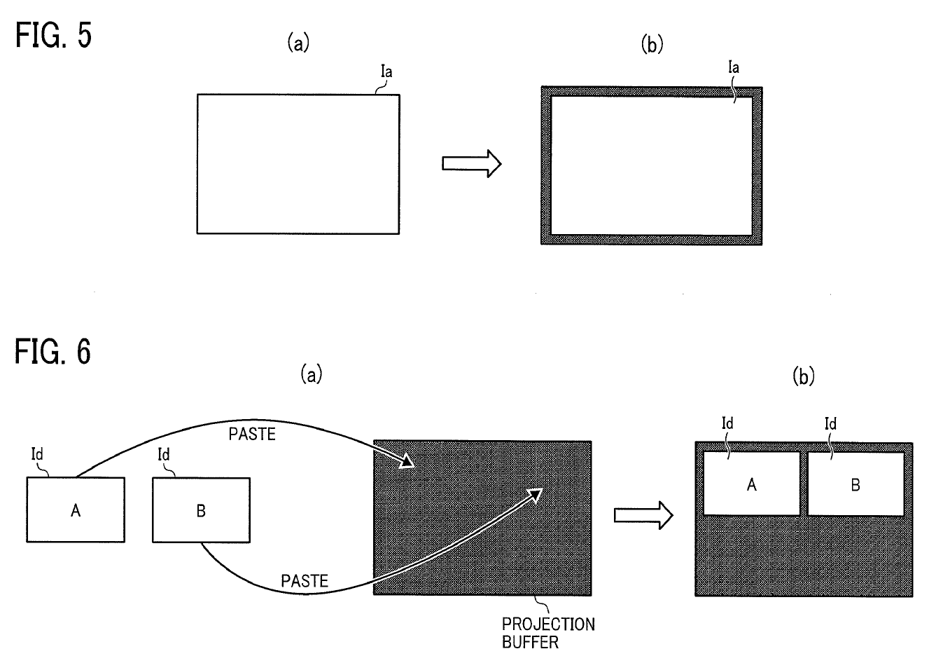

Next, a process performed by the image data output unit 115 and the projection unit 103 in the split screen projection mode and the full screen projection mode will be described. In the full screen projection mode, a full screen image generated by the image processing unit 105 is converted by the image data output unit 115 to an RGB image signal, and the RGB image signal is projected by the projection unit 103. FIG. 5 illustrates an exemplary projection screen in the full screen projection mode. Here, a full screen image Ia (FIG. 5(a)) is displayed on the entire projection screen as illustrated in FIG. 5(b).

Next, in the split screen projection mode, images generated by the split display unit 112 are combined by the composite image generator 113 into one image. This composite image is converted by the image data output unit 115 to an RGB image signal, and the RGB image signal is output as a projection screen. The projection job manager 111 manages which job (which image) is arranged at which position (which split screen), and designates this to the display switching unit 114.

FIG. 6 illustrates an exemplary projection screen and the manner of using a projection buffer in the split screen projection mode. As illustrated in FIG. 6, the composite image generator 113 combines a group of split images Ids (“split image group Id”) into one projection screen in the manner of pasting the split image group Id onto a projection buffer (FIG. 6(a)). Accordingly, the projection screen having the split images Id that are arranged is displayed (FIG. 6(b)).

### Problems in Display Switching

Split screen display realized by the above-mentioned flow looks poor when the display screen is switched from the split screen mode to the full screen mode. This switching or screen transition is not accomplishable in a moment. This is because switching the screen from the split screen mode to the full screen mode requires execution of the following: 1) start execution of a job for full screen projection, and generate an image at the beginning of a full screen; and 2) reset the screen in the split screen mode when displaying a full screen image.

This will be described using FIGS. 7 and 8. For example, it is assumed that a maximum of four jobs for split screens are being executed. In this state, a job for a full screen is also generated. In this case, two processing methods are conceivable. One is a method for generating a job for the full screen while leaving the jobs for the split screens running. This case however results in five jobs, which may deplete the resources of the memory 101 and the CPU 100. FIG. 7 illustrates screen transition in this case. More specifically, FIG. 7(a) illustrates a projection screen with four split images Ids. FIG. 7(b) illustrates how the projection screen changes its appearance, as the four jobs for split screens end, one by one. FIG. 7(c) illustrates a projection screen when all of the four jobs for split screens end. FIG. 7(d) illustrates a projection screen, with a full screen image Ia.

The other is a method for generating a job for the full screen after ending the jobs for the split screens. Since the resources are limited, it is necessary to start a job for the full screen after ending the jobs for the split screens. Although there is no need to be anxious about depletion of the computational resources in this case, the split screens are ended one by one. FIG. 8 illustrates screen transition in this case. FIG. 8(a) illustrates a projection screen with four split images Ids. FIG. 8(b) illustrates a projection screen, which is a black-out screen, to be displayed when the four jobs for split screens end, one by one. FIG. 8(c) illustrates a projection screen, which is a black-out screen, to be displayed when all of the four jobs for split screens end. FIG. 8(d) illustrates a projection screen, with a full screen image Ia.

As illustrated in FIG. 7, the first method presents a black-out screen, which looks poor, as illustrated in the entire (or partial) screen while ending displaying in the split screen mode (see FIG. 7(b)) or the entire screen when displaying in the split screen mode is completed (See FIG. 7(c)). In contrast, as illustrated in FIG. 8, the second method also presents a black-out screen while ending displaying in the split screen mode (See FIG. 8(b)) or when displaying in the split screen mode is completed (FIG. 8(c)), which also looks poor.

Next, the reason it is necessary for resetting the screen when switching the display mode from the split screen mode to the full screen mode will be described. The reason is that, for the specification of the hardware illustrated in FIG. 2, it is necessary to stop the projection and to re-generate a projection buffer when the image format or the output size changes. Switching from the split screen mode to the full screen mode involves a change in the output size, and accordingly it is necessary to re-generate a buffer. When the image format or the projection size is different between the split screen mode and the full screen mode, it is necessary to reset the screen for the sake of hardware constraints.

### Display Switching Process

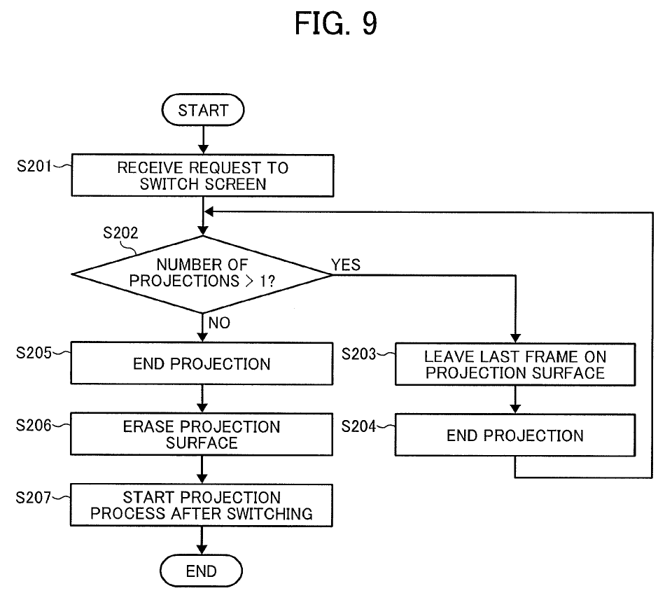

In the embodiment in view of the above-mentioned problems, when the screen is switched from the split screen mode to the full screen mode, the jobs for the split screens are ended while leaving the last screen in the split screen mode displayed. FIG. 9 illustrates the flow of this process. The process illustrated in FIG. 9 is executed by the display switching unit 114 unless otherwise noted.

When the projection job manager 111 receives a request from the user to switch the screen (S201), the display switching unit 114 determines whether a plurality of screens are being displayed, on the basis of the number of projections (S202). If the number of projections is two or greater (YES in S202), the display switching unit 114 ends the projection jobs one by one (S204) while leaving the last frame displayed (S203). Because the last screen of each of the jobs is left displayed, it seems as if the jobs are continuously running (FIG. 10).

The display switching unit 114 receives a projection start request or a projection end request from the projection job manager 111 for an image displayed on each of the split screens. The display switching unit 114 updates the number of projections on the basis of the number of received projection start requests and the number of projection end requests, and holds the updated number of projections. In short, when a projection start request is received, the display switching unit 114 increases the number of projections by one; and, when a projection end request is received, the display switching unit 114 decreases the number of projections by one. When a projection job is ended in response to a screen switching request, the display switching unit 114 decreases the number of projections by one. By having settings for switching the screen in a projection start request, the display switching unit 114 determines whether to proceed to a process of screen switching (S207), on the basis of the number of projections.

When the number of projections becomes the last one (NO in S202), the display switching unit 114 ends the last projection job (S205), and resets the projection screen (S206). As a result of S206, the screen is reset, resulting in a black screen. Thereafter, the display switching unit 114 starts a projection process after the switching (S207), and displays a full screen.

FIG. 10 illustrates transition of a projection screen while the above-described process is being performed. FIG. 10(a) illustrates a projection screen with four split images Ids. FIG. 10(b) illustrates a projection screen to be displayed when the four jobs for split screens end, one by one. FIG. 10(c) illustrates a projection screen, which is a black-put screen, to be displayed when all of the four jobs for split screens end. FIG. 10(d) illustrates a projection screen, with a full-screen image Ia.

When the above-mentioned process is performed, as illustrated in FIG. 10, at the time of switching the display screen from the split screen mode to the full screen mode, the last frame of each of the screens in the split screen projection mode, which is to be ended, remains on the projection surface (See FIG. 10(b)). In doing so, the display screen is switched smoothly from the split screen mode to the full screen mode.

In the above-described process, after the split screen mode ends, an image projected at the time of ending the split screen mode is displayed, and, when the processing in the full screen mode starts, the screen is switched to the full screen mode. At this time, the screen after the switching is an initial screen (black-out screen) (See FIG. 10(c)). In this way, the user can be informed of the fact that the processing in the full screen mode has started.

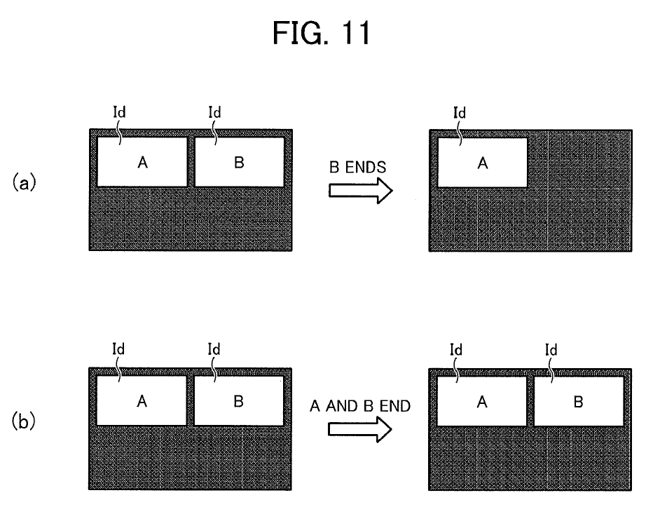

At the time of ending the split screen mode, it is preferable to prepare two modes, that is, one mode of ending the split screen mode while leaving an image, and the other mode of ending the split screen mode without leaving an image. That is, it is preferable to prepare a mode of performing the process illustrated in FIG. 9 to obtain a display appearance illustrated in FIG. 10, and another mode of ending the split screen mode without leaving an image, as illustrated in FIG. 11(a).

As illustrated in FIG. 11(a), in the mode for ending the split screen mode without leaving an image, after the job “B” for one split screen ends, only the split screen for the job “A” is displayed. FIG. 11(b) illustrates the case in which the split screen mode ends while leaving an image as described above referring to FIG. 10.

The display switching unit 114 executes a process of selecting one of these two modes and ending the split screen mode. In doing so, at the time of switching the screen from split screen display to full screen display or at the time of ending split screen display, the split screen mode ends while leaving an image, thereby preventing the screen from looking poor in that the user can perceive that the jobs are ended one by one. At the time of ending the split screens in the split screen mode, the screen of an ended job alone can be erased.

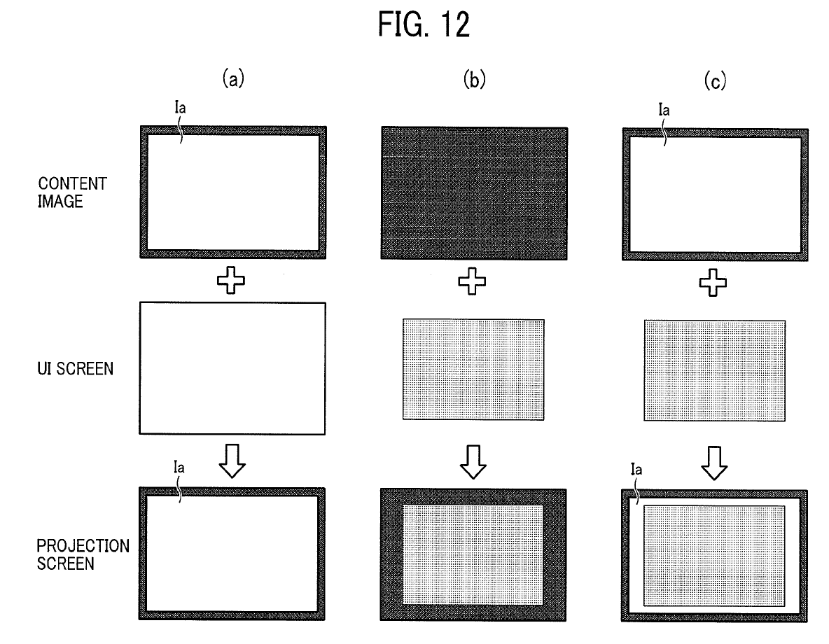

Furthermore, the display switching unit 114 particularly does not end the full screen mode while leaving the screen. FIG. 12 illustrates a display appearance in the full screen display mode. FIG. 12 illustrates the relationship between a content image of content being projected, a user interface (UI) image, and a projection screen. FIG. 12(a) illustrates the case when content data is being projected, FIG. 12(b) illustrates the case when display of content data ends, and FIG. 12(c) illustrates the case when display of content data ends while leaving an image. When the image (in this case, the content image that has been displayed as illustrated in FIG. 12(a)) is left displayed, as illustrated in FIG. 12(c), both a content screen and a standby screen are projected together on a projection screen.

This does not happen in the split screen display mode since the entire screen is ended at the time of ending the entire screen in the split screen mode after the individual split screens are ended, so that the result becomes identical to an illustration in FIG. 12(b). Because it is necessary to end the entire screen once at the time of switching the screen, it is preferable for the full screen display mode not to end while leaving the screen.

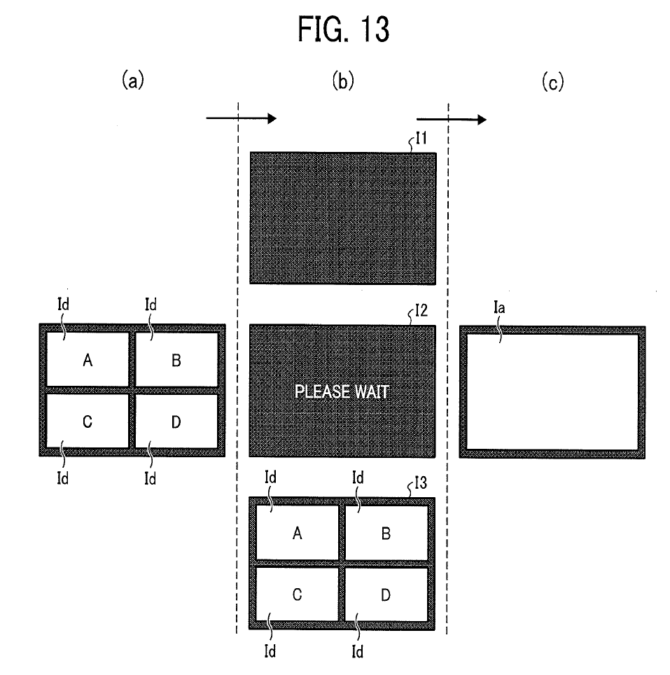

Hereinafter, another embodiment will be described with reference to FIG. 13. More specifically, FIG. 13(a) illustrates a screen, displayed when operation of ending display of the images in the split screen display mode is completed. FIG. 13(b) illustrates examples of a screen, displayed at the start of the full screen display mode. FIG. 13(c) illustrates a screen, displayed when the first image to be displayed in the full screen display mode is generated.

In one example, the display switching unit 114 switches the screen from the split screen mode to the full screen mode immediately after the process of ending content on individual split screens ends and the process of playing content on a full screen starts. In one example, a message indicating that the processing is in progress may be displayed until generation of the first image on the full screen is completed.

In the above-described example, as illustrated in FIG. 13(b), a black screen I1 is displayed at the start of the processing in the full screen mode. In this example, like a screen I2, a message such as “Please wait” which informs the user of the fact that the processing is in progress may be displayed. With such a configuration, after the split screen mode ends, an image projected at the end is projected to inform the user of the fact that the processing in the full screen mode has started.

In another example, the display switching unit 114 may switch the screen from the split screen mode to the full screen mode when the process of ending content on individual split screens ends and the image processing unit 105 completely generates the first image in the process of playing content on a full screen. In this case, a screen I3 illustrated in FIG. 13 may be displayed. In this display appearance, the screen can be switched from split screen to full screen almost without showing the user the screen being processed.

Furthermore, in another example, the display switching unit 114 may start the process of ending the split screen mode after completely generating the first image for a full screen and to switch the screen to full screen after completely ending the split screens. In this case, the time required for switching from the split screen mode to the full screen mode becomes shorter.

Furthermore, display switching control according to the above-described embodiment may be applied to the case of displaying one item of content (image), among items of content on split screens, on a full screen, and this control may be inapplicable to the full screen mode in other cases. Because how the screen looks does not matter much in the latter case, the above-mentioned configuration contributes to saving the computational resources necessary for the display switching control.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A display apparatus comprising:
a display to display, on one display screen, one or more images in one of a split screen display mode and a full screen display mode,
the split screen display mode being a mode of displaying a composite image on the display screen, the composite image including a plurality of images generated from a plurality of items of image data, that are respectively displayed on a plurality of split screens of the display screen,
the full screen display mode being a mode of displaying one image on the display screen; and
circuitry to control the display to switch between the split screen display mode and the full screen display mode,
wherein, in response to reception of a switching request to switch the display screen from the split screen display mode to the full screen display mode, the circuitry performs operation of ending display of the respective images displayed on the split screens, while keeping display of the composite image that is displayed in the split screen display mode.

2. The display apparatus according to claim 1, wherein the circuitry switches the display screen from the split screen display mode to the full screen display mode to cause the display to display one image on the display screen, after the operation of ending display of the respective images displayed on the split screens completes and operation of displaying one image on the display screen in the full screen display mode starts.

3. The display apparatus according to claim 2, wherein the circuitry displays a screen indicating that processing is in progress until a first image to be displayed on the display screen in the full screen display mode is generated.

4. The display apparatus according to claim 1, wherein the circuitry switches the display screen from the split screen display mode to the full screen display mode to cause the display to display one image on the display screen, after the operation of ending display of the respective images displayed on the split screens completes and generation of a first image to be displayed on the display screen in the full screen display mode is completed.

5. The display apparatus according to claim 1, wherein the circuitry starts operation of ending display of the respective images on the split screens after generation of a first image to be displayed on the display screen in the full screen display mode is completed, and switches the display screen from the split screen display mode to the full screen display mode to cause the display to display one image on the display screen after the operation of ending display of the respective images displayed on the split screens completes.

6. The display apparatus according to claim 1, wherein:
when the switching request requests displaying a first image of the plurality of images displayed on one of the split screens as an enlarged image, the circuitry performs operation of ending display of the images other than the first image, while keeping display of the composite image before the switching is performed, and
when the switching request requests displaying an image that is displayed on none of the split screens, the circuitry performs operation of ending display of the respective images on the split screens while not keeping display of the composite image.

7. A display control method comprising:
displaying a composite image on a display screen in a split screen display mode, the composite image including a plurality of images generated from a plurality of items of image data, that are respectively displayed on a plurality of split screens of the display screen;
receiving a switching request to switch the display screen from the split screen display mode to a full screen display mode, to request to display one image on the display screen in the full screen display mode; and
performing operation of ending display of the respective images displayed on the split screens, while keeping display of the composite image that is displayed in the split screen display mode.

8. The display control method of claim 7, further comprising:
switching the display screen from the split screen display mode to the full screen display mode to display one image on the display screen, after the step of performing operation of ending display of the respective images is completed.

9. The display control method of claim 8, further comprising:
generating a first image to be displayed on the display screen in the full screen display mode; and
displaying a screen indicating that processing is in progress until the step of generating a first image is completed.

10. The display control method of claim 7, further comprising:
generating a first image to be displayed on the display screen in the full screen display mode; and
switching the display screen from the split screen display mode to the full screen display mode to display one image on the display screen, after the step of generating a first image is completed.

11. A non-transitory recording medium which, when executed by one or more processors, cause the processors to perform a display control method comprising:
displaying a composite image on a display screen in a split screen display mode, the composite image including a plurality of images generated from a plurality of items of image data, that are respectively displayed on a plurality of split screens of the display screen;
receiving a switching request to switch the display screen from the split screen display mode to a full screen display mode, to request to display one image on the display screen in the full screen display mode; and
performing operation of ending display of the respective images displayed on the split screens, while keeping display of the composite image that is displayed in the split screen display mode.
